(19) United States
(12) Patent Application Publication
(10) Pub. No.: US 2017/0032265 A1
(43) Pub. Date: Feb. 2, 2017

(54) Computer Systems and Methods For Constructing and Validating A Psychometric Instrument For Predicting Ethical Behavior

(71) Applicants: Marc-Charles Ingerson, Provo, UT (US); Richard Nephi Williams, Provo, UT (US)

(72) Inventors: Marc-Charles Ingerson, Provo, UT (US); Richard Nephi Williams, Provo, UT (US)

(21) Appl. No.: 15/224,475

(22) Filed: Jul. 29, 2016

Related U.S. Application Data
(60) Provisional application No. 62/199,177, filed on Jul. 30, 2015.

(51) Int. Cl. G06N 7/00

(52) U.S. Cl. CPC G06N 7/00

(57) ABSTRACT

Systems and methods for predicting ethical behavior using a psychometric instrument. The method involves: computing an ethical concern score based on a first group of ethical cognition items, a second group of ethical affect items, a third group of ethical conation items, and a fourth group of ethical courage items; computing an ethical consistency score; and computing an ethical integrity score based on the ethical concern score and the ethical consistency score.

### TECHNICAL FIELD

The present invention relates, generally, to a psychometric instrument for reliably predicting ethical behavior and, more particularly, to systems and methods for constructing and validating the instrument using computer-based factor analysis, correlation, and linear regression techniques.

### BACKGROUND

The importance of integrity, transparency, and accountability in both government and the private sector cannot be overstated. Effective stewardship requires trust. Citizens, employees, and consumers expect their leaders to serve with fairness and to manage public and corporate resources responsibly. Predictable and fair minded decision making inspires trust and thus contributes to well-functioning markets, stable international relations, and economic growth. Unethical conduct by corporate officers and government officials, on the other hand, undermines public confidence and can lead to the systemic failure of private and public institutions. (See, Integrity, Transparency and Accountability in Public Administration: Recent Trends, Regional and International Developments and Emerging Issues, by Elia Armstrong, August 2005, United Nations, available at http://unpan1.un.org/intradoc/groups/public/documents/un/unp an020955.pdf, the entire contents of which are hereby incorporated herein by this reference).

Most societies view integrity as a basic tenet of human interaction. Principles of fairness, respect for others, and the value of integrity are so fundamental that they instinctively command our allegiance. Integrity is an implicit assumption underlying the belief that we should be able to count on one another regardless of context. Indeed, most Fortune 100 companies list integrity as their number one value. Nonetheless, it is simply unrealistic to expect that people and institutions will always think, speak, and otherwise act with integrity. That is, while most of us appreciate the value of integrity, many of us do not conduct ourselves with integrity on a consistent basis.

Despite its popularity as a normative descriptor, there is a lack of theoretical clarity regarding integrity in the context of business and psychology, resulting in the conflation of integrity with the related terms of honesty, morality, and ethics. Consequently, in the late 1980s scholars sought to create tests to better define and measure integrity with the idea that, if an integrity measure could predict unethical behavior, it could be used in business and industry as a talent management tool for hiring, promoting, reprimanding, and firing. Those measures include: 1) Craig and Gustafson's (1998) Perceived Leader Integrity Scale (PLIS); 2) Olson's (1998) Moral Integrity Scale (MIS); 3) Dineen, Lewicki, and Tomlinson's (2006) Behavioral Integrity Scale (BIS); and 4) Tang and Liu's (2012) Authenticity of Supervisor's Personal Integrity and Character Scale (ASPIRE).

More particularly, Craig and Gustafson noted that those who make utilitarian decisions end up being able to commit supererogatory acts that are morally commendable, but not morally required and largely define how others perceive the integrity of a leader. Therefore, Craig and Gustafson saw a need for an instrument that could help measure this.

Subsequently, Craig and Gustafson identified seven main behavioral domains as a framework for item generation consistent with their construct of integrity. These seven domains were: training and development, maliciousness, resource/workload allocation, self-protection, truth telling, procedure and policy compliance, and unlawful discrimination. Craig and Gustafson's 1998 study employed a scale consisting of 77 items (questions), and was validated against the Balanced Inventory of Desirable Responding (BIDR), the Praxis Business Ethics Inventory, and the Neo-Personality Inventory Revised (NEOPI-R), and the Organizational Climate Questionnaire. The end result of this research was the production of two versions of the PLIS, a 43-item scale and a 31-item scale.

Two strengths of the PLIS scale are that it sought to evaluate the integrity of another and predicted unethical behavior. Significantly, however, it was not designed to identify ethical behavior.

Olson's (1998) MIS measured integrity as directly related to ethical thoughts, feelings, and behaviors. Specifically, Olson found that moral integrity was positively correlated with well-being and negatively correlated with anxiety. Additionally, through factor analysis, Olson discovered that two correlated factors underlie the construct of moral integrity: the cognitive and the affective/behavioral.

Olson's MIS allows individuals to self-report in such a way that their personal moral integrity can be measured and used as a predictor of behavior, using a scale based on a conceptual congruence between cognition and affect. On the other hand, MIS has been criticized for: 1) uncertain generalizability based on the homogenous and limited sample; and, 2) less than optimal utility for researchers due to its great length and difficulty in scoring.

Dineen asked why employees emulate supervisors, using the concept of behavioral integrity which involves the alignment between an actor's words and deeds, and captures the extent to which supervisors are role models of desirable behaviors through their actions.

Dineen's BIS measured the relationship of supervisor integrity to employee organizational citizenship behaviors, with the assumption that a manager's words and actions are in harmony.

A pilot study involved a first group of 838 usable responses from one large bankcard organization using a 35-item questionnaire; and a second group of 271 usable responses from 28 retail bank branches using a 38-item questionnaire. Dineen found that relationships between supervisory guidance and the outcomes varied as a function of the degree to which supervisors were perceived to exhibit behavioral integrity. Dineen found that integrity can predict (un)ethical workplace behaviors.

Two weaknesses of the BIS are that: 1) it focuses on the perceived integrity of another as opposed to the actual integrity of the individual responding to the scale; and 2) it is not directly linked with the ethical or moral component of another individual's integrity, but only to their consistency.

Finally, the ASPIRE scale by Tang and Liu sought to predict the behavior of individuals based on the perceived integrity of their supervisors. The ASPIRE scale consisted of three inter-related sub-constructs, namely, supervisors who: (1) show honesty, fairness, and integrity; (2) care about others' work; and (3) are friendly and offer transparent decision making and professional development. ASPIRE assess these three factors with nine items on each. Each item is scored on a five point Likert-style scale. The dependent variables were self-interest and unethical behavioral intention. Participants in the study consisted of 266 business students with part-time employment, and they were asked to either review the Ten Commandments or sign an honor code. Afterwards participants were placed in a gambling environment where cheating was possible; Tang and Liu then collected and analyzed the data as to whether or not participants cheated.

Findings in Tang and Liu's (2012) ASPIRE showed: 1) low perceived supervisor integrity was related to high self-interest and low unethical behavioral intention; and 2) unethical behavior was significantly related to low self-esteem, high Machiavellianism, and low intrinsic religiosity. Succinctly, perceiving one's supervisor as low on integrity can predict unethical behavioral intention among individuals with high self-interest, but not among individuals with low self-interest.

Tang and Liu revealed that studies dealing with integrity should include both full-time workers as well as part-time workers. Second, there were no measures of attitude or personality collected. Third, the data was collected only over the course of one academic semester. And, fourth, ASPIRE treats honesty and integrity as the same when they may in fact be different constructs.

Presently known integrity tests have been shown to be either too obvious, too opaque, or too confusing, leading to questionable validity and predictive value. As described in greater detail below, the present inventors have developed a new theoretical framework for evaluating integrity, as well as a new psychometric instrument for predicting future ethical behavior which is both statistically reliable and robust in its predictive value.

Various features and characteristics will also become apparent from the subsequent detailed description and the appended claims, taken in conjunction with the accompanying drawings and this background section.

### BRIEF SUMMARY

The present invention provides a new operational definition of ethical integrity which incorporates cognition, affect, conation, and ethical courage for the purpose of predicting future ethical behavior.

A new scale for the assessment of ethical integrity is presented. The Ethical Integrity Scale (EIS) assesses the extent to which persons report thinking positively about ethics and ethical matters, the extent to which persons report feeling positively towards such matters, and the extent to which persons intend to act affirmatively toward ethical matters. However, ethical action is often required in the face of reasons and pressures against it. Thus, the EIS adds an additional component to the attitude-like nature of integrity, namely, ethical courage. Ethical courage is conceptualized in terms of the extent to which persons report recognizing the importance of and actually acting ethically even in situations where it might be hard. The mean score across these four dimensions is described as ethical concern. Results showed that the attitude-like construct of ethical concern was the strongest predictor of future (un)ethical behavior.

Various other embodiments, aspects, and features are described in greater detail below.

### BRIEF DESCRIPTION OF THE DRAWING FIGURES

Exemplary embodiments will hereinafter be described in conjunction with the appended drawing figures, wherein like numerals denote like elements, and:

FIG. 1 is an exemplary conceptual layout of an ethical integrity scale including three items for each category of courage, affect, conation, and cognition in accordance with various embodiments.

FIG. 2 is a Scree plot of Eigenvalues versus factor number.

FIG. 3 is a graph of behavior versus ethical concern.

FIG. 4 is a table for allocating money in an ultimatum game task.

### DETAILED DESCRIPTION OF PREFERRED EXEMPLARY EMBODIMENTS

The following detailed description of the invention is merely exemplary in nature and is not intended to limit the invention or the application and uses of the invention. Furthermore, there is no intention to be bound by any theory presented in the preceding background or the following detailed description.

Various embodiments of the present invention relate to systems and methods for developing and validating an ethical integrity instrument for predicting future ethical behavior.

Before describing the new psychometric instrument according to the present invention, it is instructive to first discuss a new approach to defining integrity upon which the instrument is based.

When defining integrity it is appropriate to consider both integral and integrational components, regardless of the particular moral theory espoused. For example, dishonesty suggests a lack of the integral component, whereas insincerity suggests a lack of the integrational component. Put differently, integrity could be understood as honesty in a particular situation. But using only honesty as a definition of integrity does not go far enough because it assumes that integrity is more trait-like than state-like, thereby de-emphasizing the deeply relational element in integrity. That is, personal integrity transcends the autonomous self and is expanded to viewing oneself as a member of an evaluating organization or a caring community. It is therefore appropriate to define personal integrity using both personal and relational aspects.

A proposed conception of integrity should also contribute to ethical behavior. This dimension is helpful because it considers both the hypocrisy gap and credibility gap. The gap between intention and behavior is vexing because merely possessing integrity does not guarantee that one will behave ethically, particularly when under pressure. This gap highlights the difference between behavioral integrity and ethical integrity.

The present inventors posit that integrity is more active (intentional) than passive and thus has implications for behaviors. The model of integrity developed here involves the concept of attitude, which has been expressed as a tri-partite measure of: i) a cognitive (or thinking) component; ii) an affective (or feeling) component; and iii) a conative (or intending) component. In addition, the definition of integrity developed herein contemplates consistency among these components, rather than merely deriving summative or intensity measures of affect, cognition, and conation.

In this regard, consistency involves the extent to which the components of attitude—cognition, affect, and conation—are consistent with each other. The idea of consistency can be understood in ethical situations as well. A person's ethical consistency may be manifest in the intensity and extent to which a person's ethical feelings, ethical cognitions, and ethical intentions are at similar levels. In other words, ethical consistency can be thought of as how congruent an individual's cognitions, affects, and conations are relative to ethical matters, or in ethical situations. It should be noted that this congruency (or ethical consistency) could be positive or negative depending on whether their ethical concern is high or low. Furthermore, it is proposed that ethical consistency, defined as consistency among the attitude components, mediates practice in particular ethical situations.

Integrity may thus be understood as attitude-like in nature, and manifested as ethical consistency. With this background, various measures that have sought to assess attitudinal consistency will now be described.

Kothandapani's (1971) research defined attitude as feeling, belief, and intention to act. Kothandapani found that within each component, a shared set of determinants distinct from other components could be identified. Intention-to-act was a stronger predictor of behavior than both verbalized feelings and beliefs. Kothandapani's research demonstrates the feasibility of conceptual separation of the conditioned stimulus (feeling) and discriminate stimulus (belief and intention to act) functions of attitude objects.

Kristensen, Pedersen, and Williams (2001) Religious Attitude Questionnaire further demonstrated that, when seeking to predict real behaviors based on complex decisions, all three dimensions of an attitude (cognition, affect, and conation) can facilitate an assessment of the element of consistency in attitude components.

The foregoing review of instruments used to assess consistency suggests that an empirically measureable and behaviorally predictive definition of integrity should include a consistency dimension or component. Specifically, integrity may now be conceptualized as attitude-like in nature and composed of high ethical concern plus positive ethical consistency. As previously discussed, ethical concern can be thought of as consisting of ethical thinking, ethical feeling, and ethical intending. Similarly, ethical consistency can be thought of as the extent to which an individual's cognitions, affect, and conations are congruent with each other, as the individual contemplates and confronts ethical situations.

In a preferred embodiment, the concept of ethical integrity also includes an element of ethical courage. One reason for this is because it is conceivable that an individual could think a lot about ethics, feel strongly about ethics, intend to be ethical, and be ethically consistent, yet still fail to behave ethically because s/he is unwilling to stand alone to do the right thing, especially where there are cost of doing so. Thus, the definition of ethical concern may advantageously include a dimension of ethical courage.

For the purposes of the ensuing discussion, ethical integrity may be conceptually defined as: i) a positive attitude toward ethical matters (ethical concern); ii) entailing consistency among ethical thoughts (cognition), feelings (affect) and behavioral intentions (conation); iii) coupled with ethical courage. Various computer implemented techniques for validating this operational definition algorithmically will now be described.

More particularly, Study 1 consists of the creation and development of a novel “Ethical Integrity Scale” (EIS), which involves composing a series of questions (referred to herein as items), classifying the items, and selecting (or eliminating) items using correlation matrices and exploratory factor analyses, and evaluating the inter-item reliability. In these exploratory factor analyses, statistical adequacy and convergent validity were evaluated.

### Study 1: Creating the Ethical Integrity Scale (EIS)

Study consisted of the development of an attitude-like scale to assess ethical integrity. Drawing upon attitude theory and the tri-component model in which attitudes consist of a cognitive, an affective, and a conative component, integrity is operationally defined in part as the level of consistency among those three components. The scale had as its target ethical matters, i.e. ethically relevant thinking, feeling, and behavioral intentions. Thus, the complete Ethical Integrity Scale (EIS) consisted of items relevant to thinking, items relevant to feeling, and items reflecting behavioral intentions or activities, in regard to ethical matters. During the conceptual development of the scale, an ethical courage factor was included. Thus, in its final form, the EIS is designed to assess the level of ethical concern and ethical courage (as measured by the numerical value of the scores on the four EIS subscales, i.e., cognition, affect, conation, and courage) and the degree of consistency among the scores of cognition, affect, conation, and courage subscales.

Development of the EIS involved five main steps. The first step involved the generation of 120 items related to ethical cognition, affect, behavioral intention, and courage. The second step comprised subjectively categorizing the 120 items by judges (in the study, the judges comprised fourteen university faculty and staff members). The third step involved reducing the 120 initial items to 62 subsequent items based on the judges' responses. The fourth step consisted of a rigorous statistical analysis of the 62 scale items based on participant responses (in the study, 426 undergraduate students responded to the 62-item scale). The fifth step used of exploratory factor analyses in SPSS 21 to create the final 12 item scale.

As a result, an instrument was developed that can assess a person's level of what might be termed ethical concern when such concern consists of ethical feeling, thinking, behavioral intention, and courage and of ethical consistency. Thus the scale yields scores on both ethical concern and ethical consistency, which when combined roughly assesses ethical integrity. The ethical concern dimension reflects the attitude-like nature of integrity and reflects the sort of virtue, or supervirtue traditionally associated with integrity. The ethical consistency dimension reflects the plain sense of integrity; that is, the congruency between an individual's positive thoughts, feelings, behavioral intentions, and courage towards situations that call for ethical behavior. Ethical integrity can then be thought of theoretically (and operationalized empirically) as a combination of high moral concern and positive ethical consistency.

In the item generation phase, at least two persons prepared a number of questions focusing on the categories of cognition, affect, behavioral intention, and courage regarding ethical matters. This phase created an initial pool of 120 potential scale items (see Appendix A).

The 120 items generated were then assigned to one of the attitude component categories of cognition, affect, conation, or courage, or otherwise indicated as ambiguous or problematic. The six sorting categories were Affect, Cognition, Conation, Ethical Courage, Not Sure, and Concerned about Item.

Based on the item sorting, the 120 initial items were then reduced to a pool of 62 items based on an 80% or better agreement rate among the judges' evaluations. Items that did not meet this 80% criterion or that were felt to be redundant with clearer or more highly evaluated items were eliminated from the item pool. This elimination process resulted in an initial EIS consisting of 62 items broken down in the following groupings—16 cognition items, 16 affect items, 15 behavioral intention items, and 15 ethical courage items (see Appendix B).

This initial 62-item EIS was administered to a sample of 426 undergraduate students at Brigham Young Univerity and each participant completed the scale during a fifteen-minute segment of a class which fulfilled an extra-credit opportunity option. The EIS was administered in paper-and-pencil format consisting of 62 ethical cognition, affect, behavioral intention, and courage items. The items were not labeled as to the attitude component or courage and were presented in a randomized order. Each participant was given the opportunity to read and rate the items independently using a Likert-type scale. The Likert-type scale ranged from 1-9 with the anchor points being: 1=I strongly disagree; this item does not describe me well, 5 =I am not sure if I agree or not; this item may or may not describe me, and 9=I strongly agree; this item describes me well. As data from the EIS were recorded anonymity was preserved so that no score could be matched to any particular student.

The results of the initial 62-item EIS were then analyzed using exploratory factor analysis, confirmatory factor analysis, correlation, and linear regression techniques. In this regard, the theoretical approach on which this research is based defines integrity in terms of a consistency among the attitude components affect, cognition, and conation and also courage. In fact, one motivation for creating the EIS was to assess the degree of consistency among these four ethically relevant factors. Therefore, it was hypothesized that there would be correlations among all of the four factors.

Using the guidance of David Howell's (2012) widely-respected statistics textbook and Anna Costello and Jason Osborne's (2005) widely-cited factor analysis, the collected data were analyzed by means of an exploratory factor analysis in SPSS 21 employing the following adequacy criteria: 1) a KMO and Bartlett's test of sphericity, 2) a Principal Axis Factoring extraction method, 3) a Direct Oblimin rotation method, and 4) Coefficient Display Format which sorted the correlation coefficients by size and suppressed small coefficients with an absolute value below 0.300.

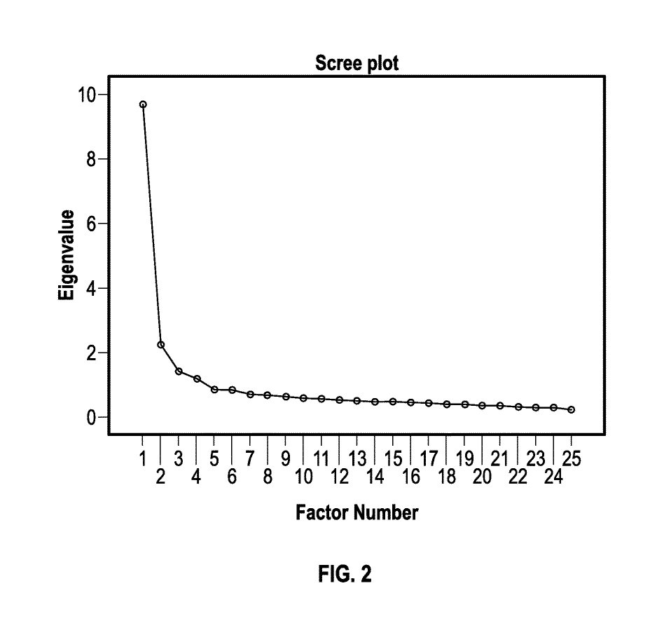

The Direct Oblimin rotation method was employed instead of Maximum Likelihood rotation method to focus on the bivariate correlations rather than semipartial correlations despite the concern of shared variance due to the theoretical perspective that all four components of ethical integrity are likely oblique and inter-dependent as opposed to orthogonal and independent. In doing this EFA, it was discovered that there were initially more natural factors, i.e., based on eigenvalue alone, than the four expected. Therefore, the EFA was rerun ignoring natural factors and the number of factors was fixed at four. Using this output, items were then eliminated if they had a loading coefficient of less than 0.300. Once all of the remaining items had a value of at least 0.300 then the EFA was rerun using the same rotation method as above. This analysis showed that there were still more than four natural factors. However, the scree plot shown in FIG. 2 indicates a significant turn after the fourth factor. Additionally, the eigenvalues indicated a drop off after four factors insofar as after the fourth factor the eigenvalues dropped below 1.000 (see Table 1).

After using an extensive iterative EFA process, each subscale was narrowed down to five items. Each of these subscales were then combined into a single scale consisting of twenty items and the same iterative EFA process was used to select the final items for each subscale in order to generate the final grand scale.

TABLE 1
Initital Eigenvalues and Total Variance Explained

| | | | | | | | Rotation |
|---|---|---|---|---|---|---|---|
| | | | | Extraction Sums of | | | Sums of |
| | Initial Eigenvalues | | | Squared Loadings | | | Squared |
| | | % of | Cumulative | | % of | Cumulative | Loadings° |
| Factor | Total | Variance | % | Total | Variance | % | Total |
| 1 | 9.664 | 38.654 | 38.654 | 9.193 | 36.771 | 36.771 | 7.738 |
| 2 | 2.235 | 8.939 | 47.593 | 1.680 | 6.721 | 43.491 | 2.699 |
| 3 | 1.416 | 5.666 | 53.259 | .927 | 3.710 | 47.201 | 4.777 |
| 4 | 1.191 | 4.764 | 58.023 | .707 | 2.827 | 50.028 | 7.362 |
| 5 | .864 | 3.455 | 61.478 | | | | |
| 6 | .847 | 3.389 | 64.866 | | | | |
| 7 | .710 | 2.841 | 67.707 | | | | |
| 8 | .686 | 2.744 | 70.450 | | | | |
| 9 | .637 | 2.546 | 72.997 | | | | |
| 10 | .590 | 2.359 | 75.356 | | | | |
| 11 | .565 | 2.260 | 77.615 | | | | |
| 12 | .535 | 2.140 | 79.755 | | | | |
| 13 | .504 | 2.015 | 81.770 | | | | |
| 14 | .492 | 1.966 | 83.736 | | | | |
| 15 | .479 | 1.914 | 85.650 | | | | |
| 16 | .430 | 1.798 | 87.448 | | | | |
| 17 | .439 | 1.755 | 89.203 | | | | |
| 18 | .407 | 1.626 | 90.830 | | | | |
| 19 | .390 | 1.559 | 92.389 | | | | |
| 20 | .374 | 1.497 | 93.886 | | | | |
| 21 | .371 | 1.484 | 95.369 | | | | |
| 22 | .331 | 1.323 | 96.693 | | | | |
| 23 | .304 | 1.214 | 97.907 | | | | |
| 24 | .290 | 1.160 | 99.067 | | | | |
| 25 | .233 | .933 | 100.000 | | | | |

Note:
Extraction Method: Principal Axis Factoring.
a. When factors are correlated, sums of squared loadings cannot be added to obtain a total variance.

The final grand scale consisted of 12 items and 4 subscales; 3 items for cognition, 3 for affect, 3 for conation, and 3 for courage (see Appendix C) for the final 12-item scale as demonstrated in Table 1 for the factor structure matrix and loadings when the Direct Oblimin rotation and Principal Axis Factoring extraction was used). The analysis was deemed a success because the generally used statistical criteria for adequacy for the final grand scale were finally satisfied (see Table 3) with the Cronbach's alpha for each of these sub-scales being 0.635 for cognition, 0.714 for affect, 0.708 for conation, and 0.814 for courage.

TABLE 2
Factor Loadings and Cross Loadings* from Exploratory Factor Analysis
of EIS Employing the Oblique Rotation Method

| Pattern Matrix | Factor 1 | Factor 2 | Factor 3 | Factor 4 |
|---|---|---|---|---|
| Courage 02_54 | .849 | | | |
| Courage 01_34 | .671 | | | |
| Courage 05_43 | .403 | | | −.330* |
| Cognition 05_50 | | .764 | | |
| Cognition 01_03 | | .658 | | |
| Cognition 02_56 | | .330 | | |
| Cognition 02_25 | | | −.707 | |
| Cognition 04_59 | | | −.682 | |
| Cognition 01_08 | | | −.547 | |
| Affect 05_62 | | | | −.774 |
| Affect 01_13 | | | | −.669 |
| Affect 03_44 | | | | −.508 |

Note:
Extraction Method: Principal Axis Factoring Rotation Method: Direct Oblimin with Kaiser Normalization
*Cross Loadings

TABLE 3
Adequacy Statistics from Factor Loadings and
Cross Loadings from Exploratory Factor
Analysis of EIS Employing the Oblique Rotation Method

| Adequacy | Values |
|---|---|
| KMO= | .853 |
| Sig= | .000 |
| Communalities= | All above .300 |
| Cumulative Variance= | 51.23 |
| Goodness of Fit= | none |
| Error Residuals= | 3.0% |
| Pattern= | All above .300 |
| Correlation Matrix= | All below .700 |

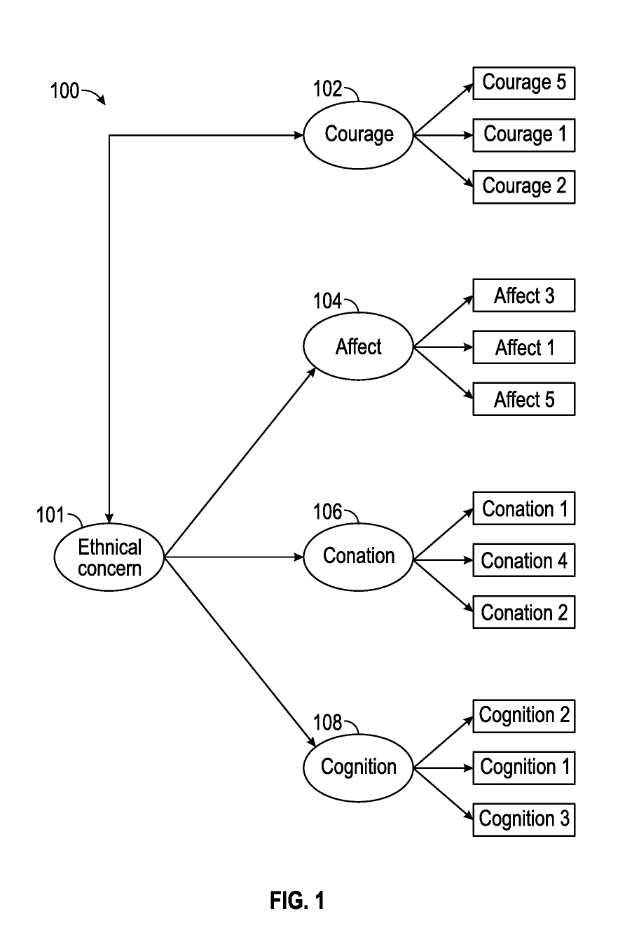

Referring now to FIG. 1, an exemplary EIS 100 includes a first category 102 of ethical courage items, a second category 104 of ethical affect items, a third category 106 of ethical conation items, and a fourth first 108 of ethical cognition items. Together, the affect, conation, and cognition items comprise the ethical concern component 101. The ethical concern component 101 may be combined with the ethical courage component 102 which, along with the notion of ethical consistency, contribute to a measure of ethical integrity.

After conducting this extensive exploratory factor analysis process under an oblique rotation using a Direct Oblimin rotation and a Principal Axis Factoring extraction method, a second exploratory factor analysis process was also conducted on the same overall data set under an orthogonal rotation using a Promax rotation and a Maximum Likelihood extraction. This was done to assess how the items might load and hang together differently. Using a similar iterative process to the one described above, this factor analysis indicated that regardless of the rotation method used, i.e., oblique or orthogonal, the final twelve items hang together in a four factor structure that satisfies the psychometric requirements for both adequacy and reliability (see Tables 4 and 5 for the orthogonal rotation results).

Factor Loadings and Cross Loadings* from Exploratory Factor Analysis
of EIS Employing the Oblique Rotation Method

| Pattern Matrix | Factor 1 | Factor 2 | Factor 3 | Factor 4 |
|---|---|---|---|---|
| Courage 0214_54 | .932 | | | |
| Courage 0109_34 | .706 | | | |
| Courage 0510_43 | .416 | .313* | | |
| Affect 0516_62 | | .807 | | |
| Affect 0103_13 | | .716 | | |
| Affect 0313_44 | | .549 | | |
| Cognition 0207_25 | | | .752 | |
| Cognition 0416_59 | | | .717 | |
| Cognition 0104_08 | | | .551 | |
| Cognition 10511_50 | | | | .774 |
| Cognition 10101_3 | | | | .668 |
| Cognition 10213_56 | | | | .330 |

Note:
Extraction Method: Maximum Likelihood. Rotation Method: Promax with Kaiser Normalization
*Cross Loadings

TABLE 5
Adequacy Statistics from Factor Loadings and
Cross Loadings from Exploratory Factor Analysis
of EIS Employing the Orthogonal Rotation Method

| Adequacy | Values |
|---|---|
| KMO= | .853 |
| Sig= | .000 |
| Communalities= | All above .300 |
| Cumulative Variance= | 51.359 |
| Goodness of Fit= | 53.345/24 = 2.26 |
| Error Residuals= | 3.0% |
| Pattern= | cross loading on Courage 05 |
| Correlation Matrix= | One above .700 |

Once this statistical stability was confirmed, the theoretical research questions as to how ethical concern, ethical consistency and ethical integrity related with the independent constructs of power, moral identity, and resilience and the dependent constructs of self-interested and deceptive behavior in a negotiation could then be operationalized, turned into research hypotheses, and tested empirically. This is described below in the context of Studies 2 and 3.

### Study 2: Ethical Concern, Ethical Consistency, Ethical Integrity, and Self-interested Behavior in a Negotiation

Study 2 evaluated the predictive validity of the Ethical Integrity Scale (EIS), as developed in Study 1, using a variation of the Ultimatum Game (see Appendix D). The predictor variables were scores from the Ethical Integrity Scale (EIS), moral identity (MIS), resilience (CD-RISC), and power. The dependent variable was self-interested behavior. It was hypothesized that ethical concern, ethical consistency, ethical integrity (from the EIS), moral identity, resilience, and power would predict self-interested behavior in a negotiation context. The design of this study also permitted a test of construct validity of the EIS as it was predicted that scores on ethical concern, ethical consistency, and ethical integrity derived from the EIS which should positively correlate with moral identity and with resilience.

Participants were 265 adults, with 136 females and 129 males. The age range of the participants was 16-79 years (M=33.0, SD=12.5). Qualtrics was used as the host in study 2 and AMT was used as the gateway to deliver a variation of the Ultimatum Game and a series of instruments and demographic questions.

The Ultimatum Game is a traditional, simple operationalization of a negotiation used primarily to investigate irrational decision-making behaviors. The Ultimatum Game typically consists of two participants, an Offerer and a Respondent. In the Ultimatum Game task, the Offerer and the Respondent decide how they will divide up a sum of money which has been allocated to them by the experimenter. To start the game, one of the two participants is randomly chosen to be the Offerer. The Offerer is the party that controls the total amount of money initially allocated for division (e.g. $10) between the two participants. The Offerer is required to offer a portion of that money (e.g. $3) to the Respondent, who can either accept or reject the offer. If the Respondent accepts the offer from the Offerer, then both receive the amount of money according to the split proposed by the Offerer (e.g. $3 to the Respondent and $7 to the Offerer). However, if the Respondent rejects the offer, then neither of the two participants gets any of the money. Thus, there was a real element of pressure to be selfish despite the relatively small amounts of money being used in the exercise.

In Study 2, all participants in the experiment were assigned to be Offerors. There were no participants that were assigned to be Respondents. This fact was not known by the participants.

After logging into the experiment, each participant was informed them that they would be matched with another online participant; however, no actual such assignment was made.

After being presented with a spooling clock icon on the screen and waiting seven seconds, each participant was directed to a new screen to engage in the Ultimatum Game task. After reading the instructions, each participant was given the opportunity to decide how much to allocate to themselves, how much to allocate to the other party, and then input the two amounts on the screen and into the computer system. After entering the divided allocation amounts and clicking next the participant was then informed that they would learn the outcome of the other party's decision by the total amount that showed up in their compensation. Finally, the participants were moved on to a new screen and started phase two of the experiment, which consisted of completing a series of scales (i.e. the EIS, the MIS, and the CD-RISC) and demographic questions.

Since there was no other online participant playing the role of Receiver, the computer automatically accepted whatever was offered and the total initial allocation amount was automatically added to the participants' total compensation. In other words, no matter what the allocation was every participant doubled their money. Each participant received their total compensation within 48 hours of completing the online study.

### Independent Variables and Manipulations

Power. Utilizing the prompts from Galinsky et al. (2003) power was manipulated by inviting the participants to engage in one of the following two exercises.
1. Please recall a particular incident in which you had power over another individual or individuals. By power, we mean a situation in which you controlled the ability of another person or persons to get something they wanted, or were in a position to evaluate those individuals. In three to five sentences, please describe this situation in which you had power—what happened, how you felt, etc; or
2. Please recall a particular incident in which someone else had power over you. By power, we mean a situation in which someone had control over your ability to get something you wanted, or was in a position to evaluate you. In three to five sentences, please describe this situation in which you did not have power—what happened, how you felt, etc.

Resilience and Moral identity. The Connor-Davidson (2003) Resilience Scale and the Aquino and Reed (2002) Moral Identity Scale were administered to each participant.

Ethical concern. Ethical concern was measured using the 12-item EIS. Ethical concern scores consisted of a combination of thinking, feeling, intending, and acting with courage to do the right thing. Ethical concern scores were created for each participant by creating a mean for each of the three items from each category (i.e. cognition, affect, conation, and courage). For example, (cognition item 1+cognition item 2+cognition item 3)/3=cognition mean. Following this procedure on the three items for each category, these means were then combined to create a new grand mean. For example, (cognition mean+affect mean+conation mean+courage mean)/4=ethical concern mean.

Ethical consistency. Ethical consistency was also measured using the EIS. Ethical consistency scores consisted of a combination of thinking, feeling, intending, and acting with courage to do the right thing. Ethical consistency scores were created for each participant by converting their individual mean scores for each category into Z scores (i.e. cognition, affect, conation, and courage). Then, the standard deviation for each of the category mean Z scores was derived. For example, the code in SPSS 21 would look like “StDev (ZCog mean, ZAff mean, ZCon mean, ZCour mean).”

Ethical integrity. Finally, ethical integrity was measured using the EIS. Ethical integrity scores were created from a combination of ethical concern scores and ethical consistency scores. This combination was done in SPSS 21 by creating two categories for each variable, i.e. high and low for both ethical concern and ethical consistency. High and low categorizations were assigned based on a numeric split that created two equal groups for both ethical concern and ethical consistency. After this forced split was done on each scalar variable, and the new categorical variables were created, a new combined variable was created from combining the two categorical variables in four different combinations. These four combinations formed the basis of a first attempt to create a single score for ethical integrity. Thus, ethical integrity scores for the initial analyses consisted of three levels: high ethical integrity (high ethical concern, high ethical consistency); mixed ethical integrity (either high ethical concern, low ethical consistency or low ethical concern, high ethical consistency); and, low ethical integrity (low ethical concern, low ethical consistency).

### Dependent Variables and Manipulations

Self-interested behavior was assessed based on the number of dimes (out of the total of ten allocated by the experimenter) that the participants allocated to themselves minus the number of dimes that they allocated to the other party in the variation of the Ultimatum Game, as shown in FIG. 4. Participants on scores ranged from 10 through −10 (M=0.679, SD=2.906).

Hypotheses:

H2a: Ethical concern will be significantly and positively correlated with moral identity and resilience.

H2b: Ethical consistency will be significantly and positively correlated with moral identity and resilience.

H2c: Ethical integrity will be significantly and positively correlated with moral identity and resilience.

H2d: Ethical concern will be negatively associated with self-interested behavior in a negotiation.

H2e: Ethical consistency will be negatively associated with self-interested behavior in a negotiation.

H2f: Ethical integrity will be negatively associated with self-interested behavior in a negotiation.

H2g: Moral identity will be negatively associated with self-interested behavior in a negotiation.

H2h: Resilience will be negatively associated with self-interested behavior in a negotiation.

H2i: Power will be positively associated with self-interested behavior in a negotiation.

### Results and Data Analysis

All data analyses were carried out in SPSS 21. Analysis was carried out through the utilization of correlations matrices and regressions.

Evaluation of the correlation coefficients revealed the following findings (see Appendix F for the Study 2 correlation matrix). Hypotheses 2a was supported in that ethical concern was positively correlated with moral identity (r (263)=0.637, p=0.000) and resilience (r (263)=0.508, p=0.000). Hypothesis 2b was not supported. Hypothesis 2c was supported in that ethical integrity was positively correlated with moral identity (r (263)=0.290, p=0.000) and resilience (r (263)=0.332, p=0.000).

Regression analyses revealed the following findings. Hypothesis 2d was supported in that ethical concern significantly predicted self-interest scores, b=−0.225, t(263)=3.748, p=0.000; ethical concern also explained a significant proportion of variance in self-interest scores, R2=0.051, F(1, 113)=14.044, p=0.000. Hypothesis 2e and 2f were not supported. Hypothesis 2g was supported in that moral identity significantly predicted self-interest scores, b=−0.202, t(263)=−3.337, p=0.001; moral identity also explained a significant proportion of variance in self-interest scores, R2=0.041, F(1, 90)=11.133, p=0.001. Hypothesis 2h and 2i were not supported.

### Study 3: Ethical Concern, Ethical Consistency, Ethical Integrity, and Deception in a Negotiation

Study 3 evaluated the predictive validity of the Ethical Integrity Scale (EIS), as developed in Study 1, using a variation of the Ultimatum Game called an Honesty Task (see Appendix G). The predictor variables were scores from the Ethical Integrity Scale (EIS), moral identity (MIS), resilience (CD-RISC), and power. The dependent variable was deceptive behavior. It was hypothesized that ethical concern, ethical consistency, ethical integrity (from the EIS), moral identity, resilience, and power would predict deceptive behavior in a negotiation context. The design of this study also permitted a test of construct validity of the EIS as it was predicted that ethical concern, ethical consistency, and ethical integrity derived from the EIS which should positively correlate with moral identity and with resilience.

Participants were 167 adults, with 97 females and 70 males. Participants were recruited online through Amazon Mechanical Turk [AMT]. The age range of the participants was 18-73 years (M=32.0, SD=13.3).

Qualtrics was used as the host for Study 3 and AMT was used as the gateway for this study to deliver a variation of the Ultimatum Game and a series of instruments and demographic questions.

Participants engaged in a negotiation task that is a specialized version of the Ultimatum Game (Thaler, 1998) which was developed by behavioral ethicist Chen Bo Zhong (2007). The Ultimatum Game is a traditional, simple operationalization of a negotiation used primarily to investigate irrational decision-making behaviors (Thaler, 1988). The Ultimatum Game typically consists of two participants that need to make a decision with real monetary consequences and this variation is no different (Zhong, 2007).

In this exercise, there are two possible roles, the Sender and the Receiver. The Sender's goal is to persuade the Receiver to make a choice. This choice is set up such that the honesty/dishonesty of the Sender can be assessed; hence the label of Honesty Task in this dissertation.

The Sender is informed that that there are two possible monetary payments (option A and option B) that have been made available to both the Sender and the Receiver. The two payment options (A and B) are then made known to the Sender. If option A is selected by the Receiver then this decision will lead to less money for the Sender. If option B is selected by the Receiver then this decision will lead to more money for the Sender.

The Sender is then informed that only s/he gets to see the monetary breakdowns for option A and option B. The Sender then has to make a choice between which of the two messages to send (i.e. message 1 or message 2). Message 1 about option A and option B is true and message 2 about option A and option B is a lie. The Sender is then informed that the message is the only information that the Receiver has to guide his/her choice. The Sender is then immediately reassured that the truthfulness of the message is only known to the Sender.

The Sender is finally given the further assurance that the Receiver will never know either the identity of the Sender or the truthfulness of the message. In other words, the key to this exercise is that the truthful message leads to the Sender getting less money whereas the untruthful message leads to the Sender getting more money. The Sender is left at the end of the instructions with the choice to send either the truthful or the untruthful message.

In Study 3, the amount of money that was impacted by the Sender's message decision totaled $1. Thus, there was a real element of pressure to be dishonest despite the relatively small amounts of money being used in the exercise.

In Study 3, all participants in the experiment were assigned to be Senders. There were no participants that were assigned to be Receivers. This fact was not known by the participants.

After logging into the experiment, each participant was informed them that they would be matched with another online participant. No actual such assignment was made.

After being presented with a spooling clock icon on the screen and waiting seven seconds, each participant was directed to a new screen to engage in the Honesty Task. After reading the instructions, each participant was given the opportunity to decide which message to send and then select that message on the screen and into the computer system. After selecting the message and clicking next the participant was then informed that they would learn the outcome of the other party's decision by the total amount that showed up in their compensation. Finally, the participants were moved on to a new screen and started phase two of the experiment, which consisted of completing a series of scales (i.e. the EIS, the MIS, and the CD-RISC) and demographic questions.

Since there was no other online participant playing the role of Receiver, the computer automatically accepted the advice in whatever message was sent and the total allocation amount was automatically added to the participants' total compensation. In other words, no matter what message the Sender selected every participant doubled their money. Each participant received their total compensation within 48 hours of completing the online study.

All measures and manipulations used in Study 3 were the same as Study 2 except for the dependent measure, i.e. deception in a negotiation (or the Honesty Task).

Deceptive behavior in a negotiation was assessed based on the message, either truthful or untruthful, that the participant chose to send to the other party in the Honesty Task.

Hypotheses:

H3a: Ethical concern will be significantly and positively correlated with moral identity and resilience.

H3b: Ethical consistency will be significantly and positively correlated with moral identity and resilience.

H3c: Ethical integrity will be significantly and positively correlated with moral identity and resilience.

H3d: Ethical concern will be negatively associated with deceptive behavior in a negotiation.

H3e: Ethical consistency will be negatively associated with deceptive behavior in a negotiation.

H3f: Ethical integrity will be negatively associated with deceptive behavior in a negotiation.

H3g: Moral identity will be negatively associated with deceptive behavior in a negotiation.

H3h: Resilience will be negatively associated with deceptive behavior in a negotiation.

H3i: Power will be positively associated with deceptive behavior in a negotiation.

### Results and Data Analysis

All data analyses were carried out in SPSS 21. Analysis was carried out through the utilization of correlations matrixes and regressions.

Evaluation of the correlation coefficients revealed the following findings (see the Study 3 correlation matrix in Appendix H). Hypotheses 3a was supported in that ethical concern was positively correlated with moral identity (r (165)=0.688, p=0.000) and resilience (r (165)=0.442, p=0.000 for resilience). Hypothesis 3b was not supported. Hypothesis 3c was supported in that ethical integrity was positively correlated with moral identity (r (165)=0.443, p=0.000) and resilience (r (165)=0.278, p=0.000).

Regression analyses revealed the following findings. Hypothesis 3d was supported wherein ethical concern both significantly predicted deception scores and explained a significant proportion of the variance in deception scores, Wald statistic equal to 7.899 which is significant at the 0.005 level. The overall model is significant at the 0.004 level according to the Model chi-square statistic. The model predicts 60.5% of the responses correctly. The Cox & Snell R Square is 0.049. Hypothesis 3e and 3f were not supported. Hypothesis 3g was supported wherein moral identity both significantly predicted deception scores and explained a significant proportion of the variance in deception scores, Wald statistic equal to 4.165 which is significant at the 0.041 level. The overall model is significant at the 0.038 level according to the Model chi-square statistic. The model predicts 57.5% of the responses correctly. The Cox & Snell R Square is 0.026. Hypothesis 3h and 3i were not supported.

### Supplemental Analyses of Study 2 and Study 3

In addition to the hypotheses tested and reported above, data from these two studies made several supplemental analyses possible. These supplemental analyses were carried out to examine several important conceptual/empirical questions related to the constructs of ethical concern, ethical consistency, and ethical integrity. These analyses suggested that ethical concern is the most important predictor of ethical behavior. These analyses also suggested that ethical consistency makes a difference in the patterns in which ethical concern will be expressed. Lastly, these analyses suggested that a single index of ethical integrity that is more predictive of behavior might be created by combining ethical concern and ethical consistency differently than done so initially.

The data in Study 2 allowed for a direct comparison of the EIS with the MIS as predictors of behaviors. A multiple linear regression analysis was used in SPSS 21 in order to develop a model for predicting self-interested behavior from these predictors of moral identity (M=6.135, SD=0.931) and ethical concern (M=7.594, SD=1.025).

Each of the predictor variables had a significant (p<0.05) zero-order correlation with self-interested behavior, but only the ethical concern predictor had significant partial effects (p=0.037) in the full model. The two predictor model was able to account for 5.6% of the variance in self-interested behavior, F(2, 263)=7.828, p<0.000, R²=0.056, 95% CI. These results suggest that the EIS accounted for more variance in behavior scores than the MIS, in that it significantly accounted for unique variance in the regression from Study 2. Thus, in Study 2 the EIS predicted (un)ethical behavior better (and accounted for more of the variance) than the MIS, which is a well-established scale in the field of behavioral ethics.

Counter to what was hypothesized, the construct of ethical consistency by itself failed to predict (un)ethical behavior in either Study 2 or Study 3. In consideration of these results, and a reconsideration of the nature of ethical concern and ethical integrity, it seems reasonable that ethical consistency alone (i.e., a person's being consistent in their “level” of cognition, affect, conation, and courage in regards to ethical matters) would not be a good predictor of behavior since if consistency is the only consideration, both high and low consistency groups would be composed of participants with either positive ethical concern (relatively and consistently high scores on cognition, affect, conation, and courage) or negative ethical concern (relatively and consistently low scores on cognition, affect, conation, and courage). Thus, the high consistency group could be composed of people having positive ethical concern and people having negative ethical concern. Therefore, any effect of high ethical consistency on behavior would be expected to be cancelled out between the groups. As such, it is important to note that there can be two types of high ethical consistency, i.e. positive and negative.

This theoretical perspective can be traced back to the Theory of Planned Behavior, which itself can be traced back to Fishbein and Ajzen's (1975) Theory of Reasoned Action, which indicates that a person's attitude can be either positive or negative regarding the behavior in question (Ajzen, 1991). Thus, for ethical consistency to be predictive it needs to be matched with ethical concern in order to assess whether the individual is high positive ethical consistency or high negative ethical consistency. Following this line of analysis, it is proposed that the construct of ethical integrity involves a combination of ethical concern and ethical consistency.

The prediction that ethical consistency might be predictive of ethical behavior was based on results from other studies employing this same attitude-like scaling technique in regards to other behaviors. However, as was noted above, there was reason to doubt that these hypotheses were reasonable because mere consistency resulted in participants at every level of ethical concern being regarded similarly in consistency. It appears that ethics, as the object for an attitude-like scale might be different from other objects, such as academic performance or religious behavior. Regardless, ethical concern, including courage, was predictive of behavior and ethical consistency was not.

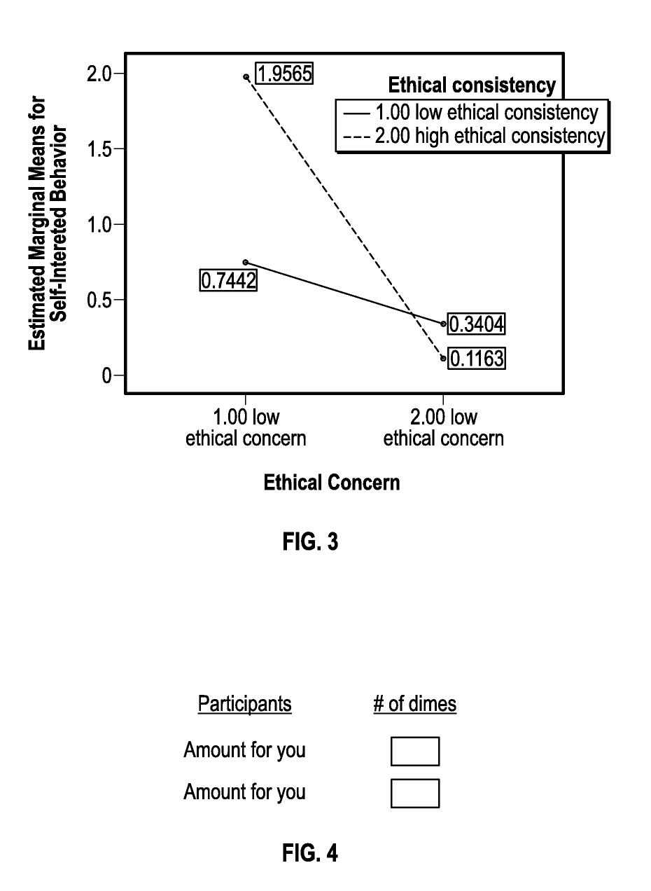

The data from Study 2 permitted a secondary analysis involving the possible role of the dimension of ethical consistency on ethical concern. A two-way, independent groups Analysis of Variance (ANOVA) was performed to check for possible interaction effects of ethical concern and ethical consistency in the prediction of ethical behaviors on the data of Study 2. The analysis was a 2 (high vs. low ethical concern) by 2 (high vs. low ethical consistency). The graph shown in FIG. 3 depicts the interaction means from the analysis.

For both of these factors the high vs. low split was made by dividing the scores such that it created two roughly equal size groups on the ethical concern and ethical consistency scores, respectively. The dependent measure for the analysis was the score on self-interested behavior. Results of the ANOVA are given in Tables 9, 10, and 11 (see Appendix I).

The main effect for ethical concern on self-interested behavior was significant and the main effect for ethical consistency on self-interested behavior was not significant (see Table 10). The interaction effect between ethical concern and ethical consistency on self-interested behavior from the ANOVA was marginally significant at the p=0.05 level, rounded to two-digits (see Table 10). Examination of the four cell means show that the highest level of self-interested behavior was in the group with high ethical consistency but low ethical concern (see Table 11). These are participants who reported low ethical concern across the cognitive, affective, conative, and courageous components, and did so consistently across the components. Contrastingly, the participants with high ethical consistency and high ethical concern had the lowest self-interest scores (see Table 11). The difference in the level of self-interested behavior between these two groups was statistically significant at below a 0.01 level (see Table 11). These results are supportive of the theoretical understanding of integrity proposed in this dissertation.

One implication of this analysis is that a single numerical index of ethical integrity would be more predictive of behavior if it somehow combed ethical concern and ethical consistency. Given the results of the initial attempt to produce and test such an index in Studies 2 and 3, it would need to be done differently than in Studies 2 and 3. Utilizing the pattern of results from the Two-Way ANOVA described above, a score for ethical integrity could be created from that pattern. The interaction term consists of four combinations of levels of ethical concern and ethical consistency: 1) high ethical concern, high ethical consistency; 2) high ethical concern, low ethical consistency; 3) low ethical concern, low ethical consistency; and 4) low ethical concern, high ethical consistency. These four combinations of concern and consistency were ranked in order of the mean self-interested behavior scores to which they correspond. Thus participants in the “high concern-high consistency” condition were assigned the rank of 4, indicating the highest level of integrity, participants in the high concern-low consistency condition a rank of 3, participants in the low concern-low consistency a rank of 2, and participants in the low concern-high consistency condition, a rank of 1. These scores represent one way of creating a single index of integrity. It is acknowledged that assigning the ranks according to the outcome of a single study is arbitrary and it is done here in the interests of exploratory data analyses of certainly needs to be refined on the basis of future research, but which might have come heuristic value as an illustrative example.

Using this new and different ranking of the single index scores of ethical integrity, the correlations and regressions from Study 2 were rerun and reanalyzed. The following results were observed. Hypothesis 2c was again supported, although more strongly, insofar that ethical integrity was positively correlated with moral identity (r (263)=0.401, p=0.000) and resilience (r (263)=0.422, p=0.000). Hypothesis 2f from Study 2 was supported insofar that ethical integrity significantly predicted self-interest scores, b=−0.202, t(263)=3.341, p=0.001; ethical integrity also explained a significant proportion of variance in self-interest scores, R2=0.041, F(1, 90)=11.161, p=0.000. Hypothesis 3c from Study 3 was again supported, although more strongly, insofar that ethical integrity was positively correlated with moral identity (r (165)=0.443, p=0.000) and resilience (r (165)=0.278, p=0.000). Hypothesis 3f from Study 3 went from being unsupported to being supported wherein ethical integrity both significantly predicted deception scores and explained a significant proportion of the variance in deception scores (Wald statistic equal to 7.424 which is significant at the 0.006 level. The overall model is significant at the 0.005 level according to the Model chi-square statistic. The model predicts 62.3% of the responses correctly. The Cox & Snell R Square is 0.045).

One additional exploratory analysis was performed, this time on the deception data from Study 3. Since the deception measure was a binary variable, the data lend themselves to a Chi Square (χ²) analysis. The four combinations of ethical concern and ethical consistency constitute a 2×2 contingency table with the number of participants in each condition who deceived during the Honesty Game providing the data for each cell. In the data, 21 participants in the high concern-high consistency deceived, 7 in the high concern-low consistency condition did so, 16 deceived in the low concern-high consistency condition, and 33 of the participants in the low concern-low consistency deceived. Chi Square analysis on this contingency table produced a significant result (χ²=12.800, df=1, p<0.000), supporting the proposition that ethical concern and ethical consistency were significantly related in their relationship with deceptive behavior in Study 3. This gives further support the possibility that a single measure of ethical integrity which takes account of both ethical concern and ethical consistency might be predictive of ethical behavior.

In summary, the additional analyses presented here supported, as did the original analyses of Study 2 and Study 3, the proposition that ethical concern is the most important predictor of ethical behavior and that ethical consistency makes a difference in the pattern in which ethical concern will be expressed. Lastly, these analyses suggested that a single index of ethical integrity that is more predictive of behavior might be created by combining ethical concern and ethical consistency in some meaningful way.

In an embodiment, the standard deviation between z-scores of the component scores may be used as an index of component consistency.

A new theoretical conception of integrity (i.e. ethical integrity) and a new scale for the assessment of ethical integrity are thus presented. The Ethical Integrity Scale (EIS) assesses the extent to which persons report thinking positively about ethics and ethical matters, the extent to which persons report feeling positively towards such matters, and the extent to which persons intend to act affirmatively toward ethical matters. These are the classical components of attitude, and in this case the attitude of integrity. However, ethical action is often required in the face of reasons and pressures against it. Thus, the EIS adds an additional component to the attitude-like nature of integrity, i.e. ethical courage. Ethical courage is conceptualized in terms of the extent to which persons report recognizing the importance of and actually acting ethically even in situations where it might be hard. The mean score across these four dimensions is described as ethical concern.

Results showed that the attitude-like construct of ethical concern was the strongest predictor of (un)ethical behavior in Study 2 and Study 3. The construct of ethical consistency failed to predict (un)ethical behavior in either Study 2 or Study 3. Power and resilience also failed to predict (un)ethical behavior in either Study 2 or Study 3.

These findings indicate that of the two dimensions of ethical integrity, i.e. concern and consistency, ethical concern is the better predictor. It is interesting to note, however, that the differences between the low ethical concern, high ethical consistency participant scores, and the low ethical concern, low consistency participant scores were significant. This difference can be attributed to the level of ethical consistency. All of these findings suggest that, as was reported in previous studies employing this sort of attitude-like scale, people who are highly consistent in their cognitive, affective, conative, and courage-related engagement with ethical matters are more predictable in regard to their ethical behavior than participants who are inconsistent across these attitude components (including courage). This effect is worthy of further investigation.

The EIS instrument provides an index of both ethical concern and ethical consistency. The results of Studies 2 suggested that consistency information can enhance predictability, i.e. high-consistency participants with low ethical concern were clearly distinguishable from high-consistency participants with high ethical concern. However, participants with low consistency and high ethical concern were not statistically distinguishable from low consistency and low ethical concern participants. In other words, in this study, at least, it seems that participants with low ethical concern were distinguishable from participants with high ethical concern only if they had high ethical consistency in the former case, and participants with low ethical consistency could not be distinguished on the basis of ethical concern. In this sense, high ethical consistency enhanced discrimination or predictability of ethically relevant behavior.

While the present invention has been described in the context of the foregoing embodiments, it will be appreciated that the invention is not so limited. For example, the various geometric features and chemistries may be adjusted to accommodate additional applications based on the teachings of the present invention.

A method is thus provided for validating a psychometric instrument for use in predicting ethical behavior. The method includes: generating a first plurality of items relating to ethical integrity; subjectively assigning each one of the plurality of items into one of the following categories: i) ethical cognition; ii) ethical affect; iii) ethical conation; iv) ethical courage; and v) other; defining a second plurality of items comprising a subset of the first plurality of items assigned to only the following categories: i) ethical cognition; ii) ethical affect; iii) ethical conation; and iv) ethical courage; administering the second plurality of items to a closed group of participants to yield a response array; computer processing the response array using predictive analytics to generate a third plurality of items comprising a subset of the second plurality of items; and evaluating the predictive validity of the third plurality of items using a self-interest test.

In an embodiment, the method further involves computing an ethical concern score for each participant based on the third plurality of items.

In an embodiment, computing the ethical concern score involves: computing a first mean score for answers in the ethical cognition category; computing a second mean score for answers in the ethical affect category; computing a third mean score for answers in the ethical conation category; computing a fourth mean score for answers in the ethical courage category; and computing a grand mean corresponding to the ethical concern score as follows:

[(first mean score)+(second mean score)+(third mean score)+(fourth mean score)]/4.

In an embodiment, the method further involves computing an ethical consistency score for each participant based on the ethical concern score and the third plurality of items.

In an embodiment, computing the ethical consistency score involves: converting the first mean score into a first z-score; converting the second mean score into a second z-score; converting the third mean score into a third z-score; converting the fourth mean score into a fourth z-score; and computing first, second, third, and fourth standard deviation values for the first, second, third, and fourth z-scores, respectively.

In an embodiment, the standard deviation between the first, second, third, and fourth z-scores comprises an index of component consistency.

In an embodiment, the method further includes computing an ethical integrity score based on the ethical concern score and the ethical consistency score.

In an embodiment, computing the ethical integrity score involves: computing a high ethical integrity range corresponding to high ethical concern and high ethical consistency; computing a mixed ethical integrity range corresponding to either high ethical concern and low ethical consistency, or low ethical concern and high ethical consistency; and computing a low ethical integrity range corresponding to low ethical concern and low ethical consistency.

In an embodiment, the self-interest test comprises at least one of an ultimatum game and an honesty test.

In an embodiment, subjectively assigning requires at least 80% agreement among independent assigning persons.

In an embodiment, the response array comprises a matrix of answers to the second plurality of items for the plurality of participants.

In an embodiment, the answers are based on a Likert scale.

In an embodiment, the predictive analytics comprise at least one of exploratory factor analysis, confirmatory factor analysis, correlation, and liner regression.

In an embodiment, the predictive analytics are implemented on a digital computer running SPSS 21.

In an embodiment, the predictive analytics are configured to satisfy at least two of the following adequacy criteria: 1) a KMO and Bartlett's test of sphericity; 2) a Principal Axis Factoring extraction method; 3) a Direct Oblimin rotation method; and 4) Coefficient Display Format.

In an embodiment, evaluating the predictive validity of the third plurality of items comprises: using predictor variables comprising the first, second, third, and fourth mean scores, and at least one of a moral identity value, a resilience value, and a power value; using a dependent variable corresponding to self-interested behavior.

In an embodiment, the third plurality of items comprises twelve items consisting of three items in each of the following categories: i) ethical cognition; ii) ethical affect; iii) ethical conation; and iv) ethical courage.

An Ethical Integrity Scale (EIS) for use in predicting future ethical behavior is provided. The EIS scale includes: a measure of ethical concern computed from a first group of ethical cognition items, a second group of ethical affect items, a third group of ethical conation items, and a fourth group of ethical courage items; and a measure of ethical consistency.

In an embodiment, the measure of ethical concern and the measure of ethical consistency are combined to predict behavior within one of the following ranges: high ethical integrity range corresponding to high ethical concern and high ethical consistency; a mixed ethical integrity range corresponding to either high ethical concern and low ethical consistency, or low ethical concern and high ethical consistency; and a low ethical integrity range corresponding to low ethical concern and low ethical consistency.

Computer code stored in a non-transient medium is also provided which, when executed by a computer processor, performs the steps of: computing an ethical concern score based on a first group of ethical cognition items, a second group of ethical affect items, a third group of ethical conation items, and a fourth group of ethical courage items; computing an ethical consistency score; and computing an ethical integrity score based on the ethical concern score and the ethical consistency score.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A method of validating a psychometric instrument for use in predicting ethical behavior, comprising:
generating a first plurality of items relating to ethical integrity;
subjectively assigning each one of the plurality of items into one of the following categories: i) ethical cognition; ii) ethical affect; iii) ethical conation; iv) ethical courage; and v) other;
defining a second plurality of items comprising a subset of the first plurality of items assigned to only the following categories: i) ethical cognition; ii) ethical affect; iii) ethical conation; and iv) ethical courage;
administering the second plurality of items to a closed group of participants to yield a response array;
computer processing the response array using predictive analytics to generate a third plurality of items comprising a subset of the second plurality of items; and
evaluating the predictive validity of the third plurality of items using a self-interest test.

2. The method of claim 1, further comprising computing an ethical concern score for each participant based on the third plurality of items.

3. The method of claim 2, wherein computing the ethical concern score comprises:
computing a first mean score for answers in the ethical cognition category;
computing a second mean score for answers in the ethical affect category;
computing a third mean score for answers in the ethical conation category;
computing a fourth mean score for answers in the ethical courage category; and
computing a grand mean corresponding to the ethical concern score as follows: [(first mean score)+(second mean score)+(third mean score)+(fourth mean score)]/4.

4. The method of claim 2, further comprising computing an ethical consistency score for each participant based on the ethical concern score and the third plurality of items.

5. The method of claim 4, wherein computing the ethical consistency score comprises:
converting the first mean score into a first z-score;
converting the second mean score into a second z-score;
converting the third mean score into a third z-score;
converting the fourth mean score into a fourth z-score; and
computing first, second, third, and fourth standard deviation values for the first, second, third, and fourth z-scores, respectively.

6. The method of claim 5, wherein the standard deviation between the first, second, third, and fourth z-scores comprises an index of component consistency.

7. The method of claim 4, further comprising computing an ethical integrity score based on the ethical concern score and the ethical consistency score.

8. The method of claim 7, wherein computing the ethical integrity score comprises:
computing a high ethical integrity range corresponding to high ethical concern and high ethical consistency;
computing a mixed ethical integrity range corresponding to either high ethical concern and low ethical consistency, or low ethical concern and high ethical consistency; and
computing a low ethical integrity range corresponding to low ethical concern and low ethical consistency.

9. The method of claim 1, wherein the self-interest test comprises at least one of an ultimatum game and an honesty test.

10. The method of claim 1, wherein subjectively assigning requires at least 80% agreement among independent assigning persons. ii. The method of claim 1, wherein the response array comprises a matrix of answers to the second plurality of items for the plurality of participants.

12. The method of claim 12, wherein the answers are based on a Likert scale.

13. The method of claim 1, wherein the predictive analytics comprise at least one of exploratory factor analysis, confirmatory factor analysis, correlation, and liner regression.

14. The method of claim 1, wherein the predictive analytics are implemented on a digital computer running SPSS 21.

15. The method of claim 14, wherein the predictive analytics are configured to satisfy at least two of the following adequacy criteria: 1) a KMO and Bartlett's test of sphericity; 2) a Principal Axis Factoring extraction method; 3) a Direct Oblimin rotation method; and 4) Coefficient Display Format.

16. The method of claim 3, wherein evaluating the predictive validity of the third plurality of items comprises:
using predictor variables comprising the first, second, third, and fourth mean scores, and at least one of a moral identity value, a resilience value, and a power value;
using a dependent variable corresponding to self-interested behavior.

17. The method of claim 1, wherein the third plurality of items comprises twelve items consisting of three items in each of the following categories: i) ethical cognition; ii) ethical affect; iii) ethical conation; and iv) ethical courage.

18. An Ethical Integrity Scale (EIS) for use in predicting future ethical behavior, comprising:
a measure of ethical concern computed from a first group of ethical cognition items, a second group of ethical affect items, a third group of ethical conation items, and a fourth group of ethical courage items; and
a measure of ethical consistency.

19. The EIS of claim 18, wherein the measure of ethical concern and the measure of ethical consistency are combined to predict behavior within one of the following ranges:
high ethical integrity range corresponding to high ethical concern and high ethical consistency;
a mixed ethical integrity range corresponding to either high ethical concern and low ethical consistency, or low ethical concern and high ethical consistency; and
low ethical integrity range corresponding to low ethical concern and low ethical consistency.

20. Computer code stored in a non-transient medium which, when executed by a computer processor, performs the steps of:
computing an ethical concern score based on a first group of ethical cognition items, a second group of ethical affect items, a third group of ethical conation items, and a fourth group of ethical courage items;
computing an ethical consistency score; and
computing an ethical integrity score based on the ethical concern score and the ethical consistency score.
